(19) United States
(12) Patent Application Publication
(10) Pub. No.: US 2026/0253346 A1
(43) Pub. Date: Aug. 27, 2026

(54) INFORMATION PROCESSING DEVICE THAT COMBINES VIRTUAL IMAGE WITH REAL IMAGE

(71) Applicant: CANON KABUSHIKI KAISHA, Tokyo (JP)

(72) Inventor: MAKOTO IKEDA, Kanagawa (JP)

(21) Appl. No.: 19/433,267

(22) Filed: Dec. 26, 2025

(30) Foreign Application Priority Data
Feb. 26, 2025 (JP) 2025-028663

(51) Int. Cl. G06T 19/00; G06F 3/01; G06T 3/40; G06T 7/50

(52) U.S. Cl. CPC G06T 19/006; G06F 3/012; G06F 3/013; G06T 3/40; G06T 7/50

(57) ABSTRACT

An information processing device acquires a first real image having a first resolution, a second real image representing a part of the first real image and having a second resolution, position and orientation information regarding a position and an orientation of an HMD, a first virtual image having a third resolution, and a second virtual image representing a part of the first virtual image and having a fourth resolution, corrects the first virtual image and the second virtual image on a basis of a change in the position and orientation information, generates a first composite image by combining the first virtual image after the correction with the first real image, generates a second composite image by combining the second virtual image after the correction with the second real image, and combines the second composite image with the first composite image.

### BACKGROUND

### Field of the Technology

The present disclosure relates to an information processing device that combines a virtual image with a real image, and more particularly, to a technology for generating an image of a mixed reality space.

### Description of The Related Art

A so-called mixed reality (MR) technology is known as a technology for fusing a real world and a virtual world in real time and seamlessly. As a system using an MR technology, an MR system including a video see-through type head mounted display (hereinafter, simply referred to as HMD) has been proposed. In the MR system, a range that substantially matches the range of the real space observed from the pupil position of the user wearing the HMD on the head is captured by an imaging unit provided in the HMD. Then, a display image is generated by combining (superimposing) computer graphics (CG) with the obtained captured image. By displaying this display image on the HMD, the user can experience the MR space.

As a technique used in an MR system, a technique has been proposed in which, when CG is drawn, a portion corresponding to a region (and its periphery) gazed by a user is drawn with high resolution, and other portions are drawn with low resolution. This technique is called foveated rendering or the like. With the foveated rendering, it is possible to reduce the load of the CG rendering processing. A human has a visual characteristic that an amount of information that can be recognized decreases as the distance from the focal position increases. Thus, the influence of the resolution reduction due to the foveated rendering on the user's bodily sensation is extremely small (the resolution reduction does not affect the bodily sensation).

In the MR system, many processes are performed from imaging to display, such as exposure processing and image processing for obtaining a captured image, detection of the position and orientation of the HMD, image processing (drawing of CG, composition of CG and the captured image, and the like) for obtaining a display image, and data transmission. Depending on the time required for these processes, the display image follows the movement of the user's head with a delay, and this delay may give the user a sense of discomfort.

Japanese Patent Laid-Open No. 2019-028368 discloses a technique for performing reprojection of an image after foveated rendering on the basis of the position and orientation of the HMD.

However, in the technique disclosed in Japanese Patent Laid-Open No. 2019-028368, since one image including the high resolution region and the low resolution region is generated, data transmission for the same number of pixels as the high resolution region is required even in the low resolution region. Furthermore, the high resolution region moves from the gazed region of the user due to reprojection of the image after foveated rendering, and this movement may give the user a sense of discomfort.

### SUMMARY

The present disclosure provides a technology capable of obtaining an image of a mixed reality space (a space obtained by fusing a real space and a virtual space) without causing a sense of discomfort with a small processing load.

The present disclosure in its first aspect provides an information processing device including one or more processors and/or circuitry configured to execute real image acquisition processing of acquiring a first real image that represents a real space and has a first resolution, and a second real image that represents a part of the first real image and has a second resolution higher than the first resolution, execute information acquisition processing of acquiring position and orientation information that is information regarding a position and an orientation of a head mounted display (HMD), execute virtual image acquisition processing of acquiring a first virtual image corresponding to the first real image, representing a virtual object, and having a third resolution, and a second virtual image corresponding to the second real image, representing a part of the first virtual image, and having a fourth resolution higher than the third resolution, execute correction processing of, on a basis of a difference between position and orientation information at a first timing and position and orientation information at a second timing after the first timing, correcting the first virtual image at the first timing so as to correspond to a first real image at a third timing after the first timing, and correcting the second virtual image at the first timing so as to correspond to the second real image at the third timing, and execute compositing processing of generating a display image to be displayed on the HMD by generating a first composite image by combining the first virtual image after the correction processing with the first real image at the third timing, generating a second composite image by combining the second virtual image after the correction processing with the second real image at the third timing, and combining the second composite image with the first composite image.

The present disclosure in its second aspect provides a control method of an information processing device, including acquiring a first real image that represents a real space and has a first resolution, acquiring a second real image that represents a part of the first real image and has a second resolution higher than the first resolution, acquiring position and orientation information that is information regarding a position and an orientation of a head mounted display (HMD), acquiring a first virtual image corresponding to the first real image, representing a virtual object, and having a third resolution, acquiring a second virtual image corresponding to the second real image, representing a part of the first virtual image, and having a fourth resolution higher than the third resolution, on a basis of a difference between position and orientation information at a first timing and position and orientation information at a second timing after the first timing, correcting the first virtual image at the first timing so as to correspond to a first real image at a third timing after the first timing, correcting the second virtual image at the first timing so as to correspond to the second real image at the third timing, on a basis of the difference, generating a first composite image by combining the first virtual image after the correction with the first real image at the third timing, generating a second composite image by combining the second virtual image after the correction with the second real image at the third timing, and generating a display image to be displayed on the HMD by combining the second composite image with the first composite image.

The present disclosure in its third aspect provides a non-transitory computer readable medium that stores a program, wherein the program causes a computer to execute a control method of an information processing device, the control method including acquiring a first real image that represents a real space and has a first resolution, acquiring a second real image that represents a part of the first real image and has a second resolution higher than the first resolution, acquiring position and orientation information that is information regarding a position and an orientation of a head mounted display (HMD), acquiring a first virtual image corresponding to the first real image, representing a virtual object, and having a third resolution, acquiring a second virtual image corresponding to the second real image, representing a part of the first virtual image, and having a fourth resolution higher than the third resolution, on a basis of a difference between position and orientation information at a first timing and position and orientation information at a second timing after the first timing, correcting the first virtual image at the first timing so as to correspond to a first real image at a third timing after the first timing, correcting the second virtual image at the first timing so as to correspond to the second real image at the third timing, on a basis of the difference, generating a first composite image by combining the first virtual image after the correction with the first real image at the third timing, generating a second composite image by combining the second virtual image after the correction with the second real image at the third timing, and generating a display image to be displayed on the HMD by combining the second composite image with the first composite image.

Features of the present disclosure will become apparent from the following description of embodiments with reference to the attached drawings. The following description of embodiments is described by way of example.

### BRIEF DESCRIPTION OF THE DRAWINGS

FIG. 1 is an external view of an MR system.

FIG. 2 is a block diagram of the MR system.

FIG. 3A is a schematic diagram of an imaging operation.

FIG. 3B is a schematic diagram of a gazed region, an entire region, a gazed real image, and an entire real image.

FIG. 4 is a schematic diagram of a gazed region, an entire region, a gazed virtual image, and an entire virtual image.

FIGS. 5A to 5D are schematic diagrams of processing of a gazed CG correction unit.

FIG. 6 is a schematic diagram of processing of an entire CG correction unit.

FIG. 7A is a schematic diagram of processing of a gazed image compositing unit.

FIG. 7B is a schematic diagram of processing of an entire image compositing unit.

FIG. 8 is a schematic diagram of processing of a display image compositing unit.

FIG. 9 is a schematic diagram of an image transmitted from an image processing device to an HMD.

FIG. 10 is a block diagram of an MR system.

### DESCRIPTION OF THE EMBODIMENTS

### First Embodiment

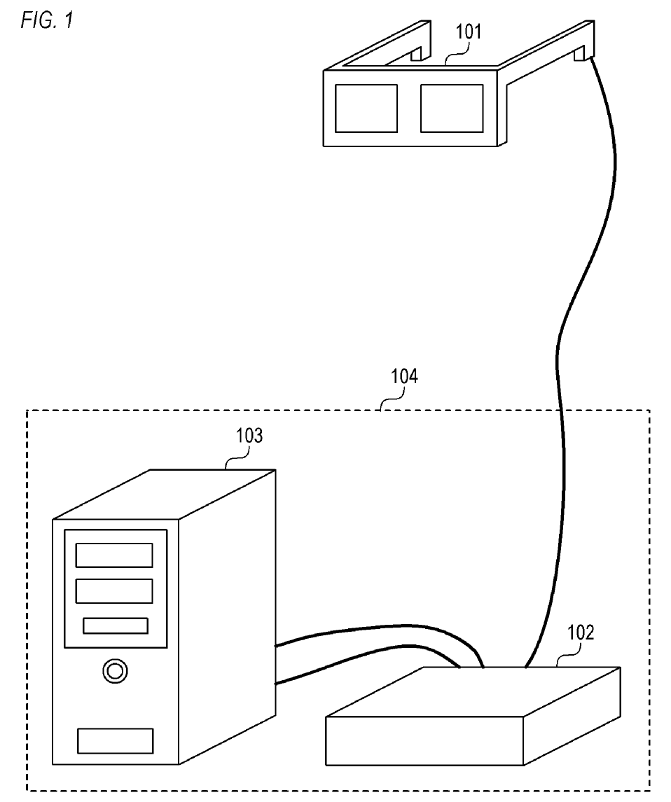

Hereinafter, a first embodiment of the present disclosure will be described. FIG. 1 is an external view illustrating an example of an external appearance of a mixed reality (MR) system according to the first embodiment. The MR system of FIG. 1 includes a head mounted display (HMD) 101 and an image processing device 104. The image processing device 104 includes a controller 102 and a personal computer (PC) 103.

The HMD 101 is a video see-through type head mounted display. The HMD 101 captures an image of the real space and receives a virtual image (image of virtual object, CG image) from the controller 102. Then, the HMD 101 generates a display image that is an image of a mixed reality space (space in which the real space and the virtual space are fused) obtained by combining (superimposing) the virtual image with the real image (captured image of the real space), and displays the display image. The HMD 101 transmits the real image to the controller 102. Furthermore, the HMD 101 detects the position and orientation of the HMD 101, and transmits position and orientation information that is the detection result to the controller 102. The position and orientation information of the HMD 101 only needs to be information regarding the position and orientation of the HMD 101, and is, for example, information indicating the position and orientation of the HMD 101.

Note that a method of supplying power to the HMD 101 is not particularly limited, and the HMD 101 may operate with power supplied from the controller 102 or may operate with power supplied from a battery provided in the HMD 101. The connection between the HMD 101 and the controller 102 may be a wired connection or a wireless connection. The HMD 101 and the controller 102 may be connected in both a wired and wireless manner. The controller 102 may be a part of the HMD 101 or a part of the PC 103. The image processing device 104 (the controller 102 and the PC 103) may be a part of the HMD 101. A part of the processing of the HMD 101 may be performed by the controller 102 or the PC 103. That is, the information processing device to which the present disclosure is applied may be included in the HMD 101, the controller 102, or the PC 103.

The controller 102 relays between the HMD 101 and the PC 103. The controller 102 performs various image processing (resolution conversion, color space conversion, distortion correction, encoding, and the like) on the real image transmitted from the HMD 101, and transmits the real image after the image processing to the PC 103. Similarly, the controller 102 transmits the position and orientation information transmitted from the HMD 101 to the PC 103. In addition, the controller 102 performs various image processing (resolution conversion, color space conversion, distortion correction, encoding, and the like) on the virtual image transmitted from the PC 103, and transmits the virtual image after the image processing to the HMD 101.

The PC 103 estimates the position and orientation of the HMD 101 (the position and orientation of the imaging unit included in the HMD 101) on the basis of the captured image and the position and orientation information received from the controller 102. Then, the PC 103 generates a virtual image that is an image of a virtual object (virtual space) viewed at the estimated position and orientation, and transmits the generated virtual image to the controller 102.

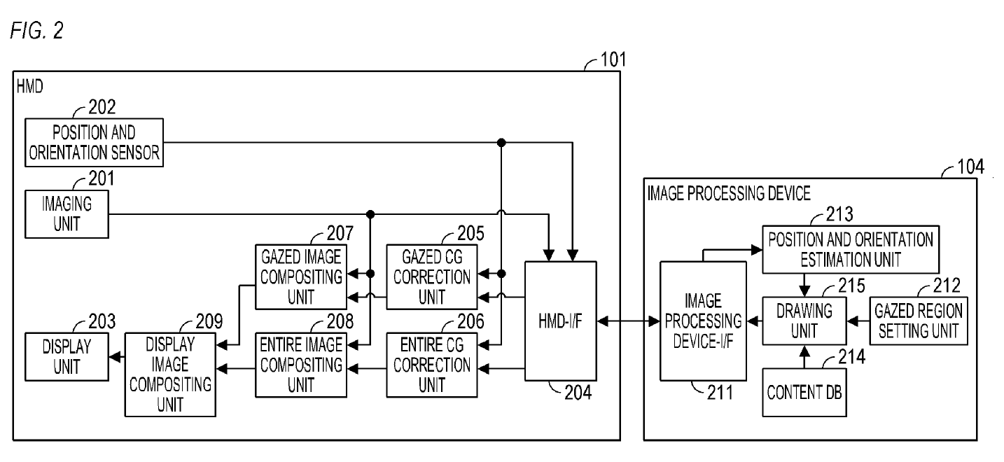

FIG. 2 is a block diagram illustrating a configuration example of the MR system according to the first embodiment. The HMD 101 includes an imaging unit 201, a position and orientation sensor 202, a display unit 203, an HMD-I/F 204, a gazed CG correction unit 205, an entire CG correction unit 206, a gazed image compositing unit 207, an entire image compositing unit 208, and a display image compositing unit 209. The image processing device 104 includes an image processing device-I/F 211, a gazed region setting unit 212, a position and orientation estimation unit 213, a content DB 214, and a drawing unit 215.

The imaging unit 201 is a camera that images a real space. In the first embodiment, the imaging unit 201 includes an imaging unit for the left eye of the user (the user wearing the HMD 101 on the head) and an imaging unit for the right eye of the user. The imaging unit for the left eye generates and outputs a real image for the left eye (real image representing the appearance of the left eye). The imaging unit for the right eye generates and outputs a real image for the right eye (real image representing the appearance of the right eye). That is, the imaging unit 201 generates and outputs a stereo image including two images (real image corresponding to the left eye and real image corresponding to the right eye) having parallax. The generation and output of the stereo image (real image corresponding to the left eye and real image corresponding to the right eye) are repeatedly performed at a predetermined frame rate.

Each of the imaging unit for the left eye and the imaging unit for the right eye includes an optical system (lens) and an imaging element (image sensor). Light from the outside world is incident on the imaging element via the optical system, and the imaging element outputs an image corresponding to the incident light. The optical axis direction (imaging direction) of the imaging unit for the left eye preferably substantially matches the line-of-sight direction of the left eye, and the optical axis direction (imaging direction) of the imaging unit for the right eye preferably substantially matches the line-of-sight direction of the right eye.

The imaging element to be used in the imaging unit 201 is determined in consideration of various parameters such as the number of pixels, image quality, noise, sensor size, power consumption, and cost. A rolling shutter type imaging element may be used, or a global shutter type imaging element may be used. One of the imaging element of the rolling shutter type and the imaging element of the global shutter type may be selected and used according to the application of the real image or the like. One real image may be generated using (in combination) both the rolling shutter type imaging element and the global shutter type imaging element. For example, when a real image (real image combined with a virtual image) to be used for generating a display image is acquired, a rolling shutter type imaging element capable of acquiring a higher quality real image may be used. When a real image used for various types of alignment is acquired, a global shutter type imaging element capable of acquiring a real image without image blur may be used. Image blur is a phenomenon that occurs in the case of the rolling shutter type in which the exposure processing is performed line by line, and is a phenomenon that the object is deformed to flow and recorded when the imaging unit or the object moves due to a difference in the timing of the exposure processing of each line. In the case of the global shutter type, since the exposure processing of all the lines is performed simultaneously, image blur does not occur.

In the first embodiment, the imaging unit 201 performs foveated capture of capturing each of the gazed region of the user and the entire region including the gazed region.

In general, the larger the number of pixels, the larger the load of processing using an image. However, there is known a human visual characteristic that a shape, a color, and the like in a peripheral field of view are less perceptible than a shape, a color, and the like in a central field of view. Due to this visual characteristic, even when an image in which the resolution of the peripheral field of view is lower than the resolution of the central field of view (gazed region) is displayed, it is difficult for the user to perceive that the resolution of the peripheral field of view is low. By limiting the region with high resolution to the gazed region, the processing load can be reduced without impairing the MR experience of the user. Accordingly, in order to obtain a display image in which the resolution of the peripheral field of view is lower than the resolution of the gazed region, a high resolution real image (gazed real image) representing only the gazed region and a low resolution real image (entire real image) representing the entire region are acquired by foveated capture.

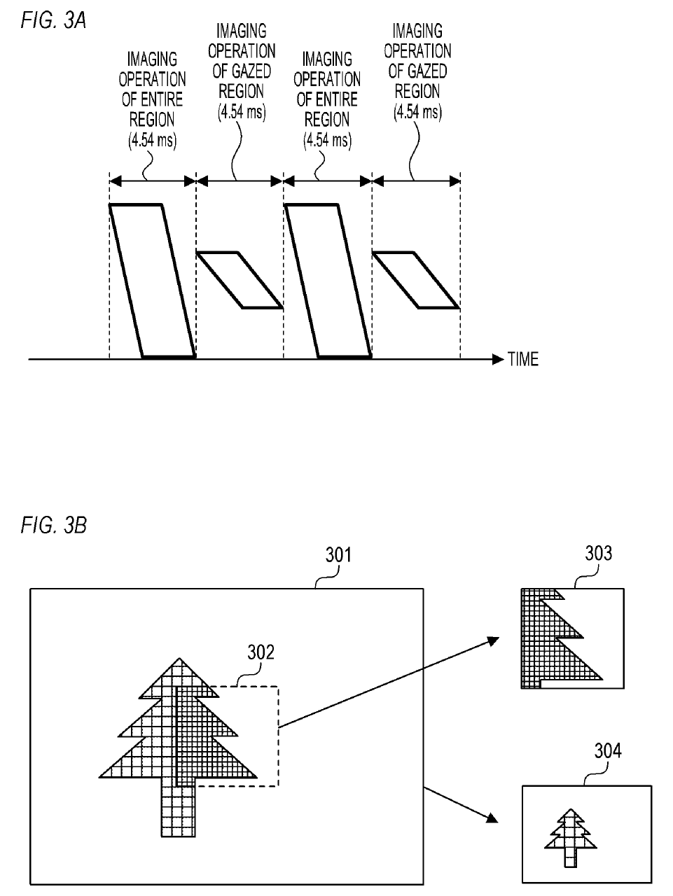

FIG. 3A is a schematic diagram illustrating an example of an imaging operation (accumulation and readout operation and real image acquisition) of imaging unit 201. The horizontal axis in FIG. 3A indicates time, and the vertical axis in FIG. 3A indicates the position (row) of the imaging element. In a case where the imaging element of the imaging unit 201 is a general CMOS sensor (rolling shutter type), as illustrated in FIG. 3A, the timing of the imaging operation of each line is different, and the imaging operation of one frame (imaging operation of one image) is expressed by a parallelogram. For example, it is assumed that the gazed real image is acquired so that one pixel of the imaging unit 201 (imaging element) corresponds to one pixel of the gazed real image, and an entire real image is acquired so that four pixels in two rows and two columns of the imaging unit 201 correspond to one pixel of the entire real image. In this case, the resolution of the entire real image is 1/4 of the resolution of the gazed real image. The values of the plurality of pixels of the imaging unit 201 may be combined to acquire the value of one pixel of the entire real image, or some of the plurality of pixels of the imaging unit 201 may be thinned out and the values of the remaining pixels may be adopted as the values of the plurality of pixels of the entire real image.

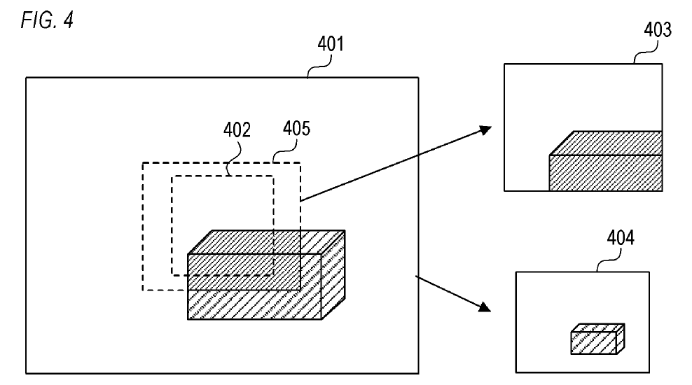

In FIG. 3A, an imaging operation for acquiring an entire real image and an imaging operation for acquiring a gazed real image are alternately performed. In FIGS. 3A, 4.54ms are required for the imaging operation for acquiring the entire real image. An imaging operation for acquiring the gazed real image also requires 4.54 ms. Although details will be described later, since one display image is generated using one entire real image and one gazed real image, the display image is generated and displayed at 110 fps.

FIG. 3B is a schematic diagram illustrating an example of the gazed region, the entire region, the gazed real image, and the entire real image. In FIG. 3B, a central portion of an entire region 301 is set as a gazed region 302. A gazed real image 303 represents the gazed region 302 and an entire real image 304 represents the entire region 301. In FIG. 3B, the gazed real image 303 is an image at equal magnification (1x), and the entire real image 304 is an image at 1/4 magnification. When the magnification of the gazed real image 303 and the magnification of the entire real image 304 are matched, the resolution (the number of pixels per inch) of the entire real image 304 is 1/4 of the resolution of the gazed real image 303. Note that, in FIG. 3B, the central portion of the entire region 301 is set as the gazed region 302, but the position and size of the gazed region 302 are not limited to those illustrated in FIG. 3B. The position and size of the gazed region are set by the gazed region setting unit 212.

The position and orientation sensor 202 detects the position and orientation of the HMD 101 and outputs position and orientation information of the HMD 101. The position and orientation sensor 202 includes, for example, a magnetic sensor (including a geomagnetic sensor), an ultrasonic sensor, an acceleration sensor, an angular velocity sensor, and the like.

The HMD-I/F 204 is a communication interface that communicates with the image processing device 104. The HMD-I/F 204 transmits the real image output from the imaging unit 201 and the position and orientation information output from the position and orientation sensor 202 to the image processing device 104. Furthermore, the HMD-I/F 204 receives the virtual image output from the drawing unit 215 from the image processing device 104 (virtual image acquisition). The HMD-I/F 204 also transmits and receives setting information and a control signal of each device.

The image processing device-I/F 211 is a communication interface that communicates with the HMD 101. The image processing device-I/F 211 receives the real image output from the imaging unit 201 and the position and orientation information output from the position and orientation sensor 202 from the HMD 101. Furthermore, the image processing device-I/F 211 transmits the virtual image output from the drawing unit 215 to the HMD 101. The image processing device-I/F 211 also transmits and receives setting information and a control signal of each device.

The position and orientation estimation unit 213 estimates the position and orientation of each of the imaging unit for the left eye and the imaging unit for the right eye on the basis of the real image and the position and orientation information received from the HMD 101 via the image processing device-I/F 211. For this estimation processing, various known techniques can be used.

The content DB 214 is a database in which various types of data (virtual space data) necessary for drawing a virtual image are stored in advance. For example, the virtual space data includes data (for example, data defining a geometric shape, a color, a texture, a position, an orientation, and the like of a virtual object) defining a virtual object. The virtual space data also includes data defining a virtual light source (for example, data defining the type, the position, the orientation, and the like of the virtual light source) and the like.

The drawing unit 215 generates a virtual image using the virtual space data stored in the content DB 214. The drawing unit 215 generates a virtual image for the left eye and a virtual image for the right eye. The drawing unit 215 generates an image of a virtual object viewed from the position and orientation of the imaging unit for the left eye estimated by the position and orientation estimation unit 213 as a virtual image for the left eye. Similarly, the drawing unit 215 generates an image of a virtual object viewed at the position and orientation of the imaging unit for the right eye estimated by the position and orientation estimation unit 213 as a virtual image for the right eye.

In the first embodiment, the drawing unit 215 performs foveated rendering for generating two virtual images respectively corresponding to the gazed region of the user and the entire region including the gazed region. The foveated rendering of the first embodiment is different from conventional foveated rendering that generates one image in which the resolution of the gazed region and the resolution of the other region are different. In order to obtain a display image in which the resolution of the peripheral field of view is lower than the resolution of the gazed region, a high resolution virtual image (gazed virtual image) representing only the gazed region and a low resolution virtual image (entire virtual image) representing the entire region are obtained by foveated rendering. The gazed virtual image is a virtual image corresponding to the gazed real image, and the entire virtual image is a virtual image corresponding to the entire real image.

FIG. 4 is a schematic diagram illustrating an example of a gazed region, an entire region, a gazed virtual image, and an entire virtual image. In FIG. 4, the central portion of an entire region 401 is set as a gazed region 405. A gazed virtual image 403 represents the gazed region 405, and an entire virtual image 404 represents the entire region 401. A region 402 is a region having the same position and size as the gazed region (the gazed region considered in the foveated capture) represented by the gazed real image. The gazed region 405 (the gazed region considered for foveated rendering) is larger than the region 402 and includes the entire region 402. As described above, in the first embodiment, the range of the gazed virtual image is wider than the range of the gazed real image. In FIG. 4, the gazed virtual image 403 is an image at equal magnification (1x), and the entire virtual image 404 is an image at 1/4 magnification. When the magnification of the gazed virtual image 403 and the magnification of the entire virtual image 404 are matched, the resolution (the number of pixels per inch) of the entire virtual image 404 is 1/4 of the resolution of the gazed virtual image 403. Note that, in FIG. 4, the central portion of the entire region 401 is set as the gazed region 405, but the position and size of the gazed region 405 are not limited to those illustrated in FIG. 4. The position and size of the gazed region are set by the gazed region setting unit 212. The range of the gazed virtual image may be equal to the range of the gazed real image.

In the first embodiment, it is assumed that the resolution of the gazed real image is equal to the resolution of the gazed virtual image, but they may be different. Similarly, it is assumed that the resolution of the entire real image is equal to the resolution of the entire virtual image, but they may be different.

The gazed region setting unit 212 sets the position (coordinates) and size of the gazed region to be used by the imaging unit 201, the drawing unit 215, the gazed CG correction unit 205, and the display image compositing unit 209. For example, the gazed region setting unit 212 sets a region designated by the user as the gazed region. The gazed region may be a fixed region such as a central portion of the entire region.

The gazed CG correction unit 205 corrects the gazed virtual image received from the image processing device 104 via the HMD-I/F 204 on the basis of the change in the position and orientation information output from the position and orientation sensor 202. Here, the timing at which the position and orientation information (and the real image corresponding thereto) is acquired and the virtual image is generated is set as timing T1, and the timing at which the gazed CG correction unit 205 (and the entire CG correction unit 206) performs processing is set as timing T2. The timing T2 is later than the timing T1. The gazed CG correction unit 205 corrects the gazed virtual image at the timing T1 on the basis of a difference between the position and orientation information at the timing T1 and the position and orientation information at the timing T2 so as to correspond to the gazed real image at the timing T2. The gazed CG correction unit 205 changes the shape, size, and the like of the gazed virtual image so that the image of the virtual object viewed from the position and orientation of the HMD 101 (imaging unit) at the timing T2 can be obtained. The processing of changing the shape, size, and the like of the gazed virtual image includes a horizontal shift, a vertical shift, magnification, reduction, geometric transformation (for example, homography transformation), and the like. Then, the gazed CG correction unit 205 extracts an image of a region that matches the region (gazed region) of the gazed real image at the timing T2 from the gazed virtual image after changing the shape, size, and the like, and outputs the extracted image as a gazed virtual image after correction.

Note that the gazed CG correction unit 205 may correct the gazed virtual image at the timing T1 so as to correspond to the gazed real image at timing T3 after the timing T2 on the basis of the change in the position and orientation information from the timing T1 to the timing T2. The timing T3 is, for example, a timing at which the gazed image compositing unit 207 (and the entire image compositing unit 208) performs processing.

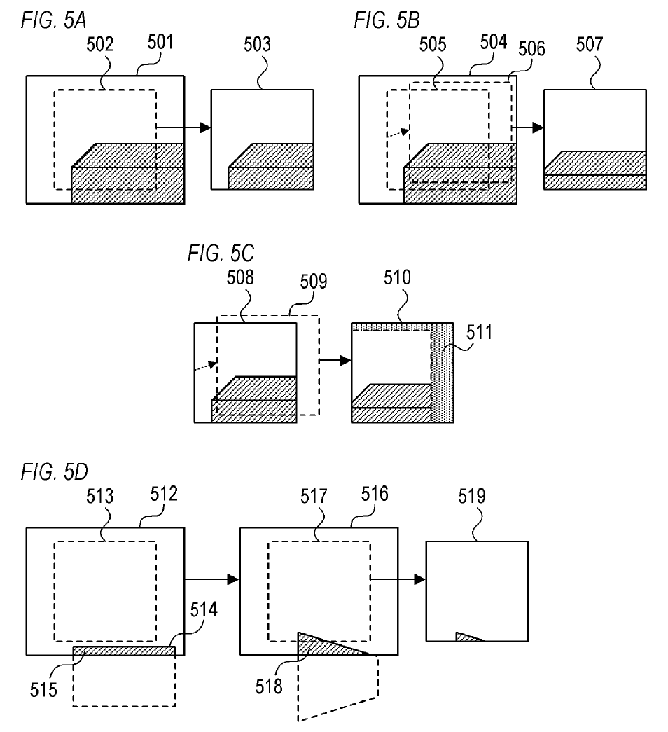

FIGS. 5A to 5D are schematic diagrams illustrating an example of processing of the gazed CG correction unit 205.

FIG. 5A illustrates an example in which the position and orientation information has not changed. An image 501 is a gazed virtual image before correction, and a region 502 is a region that matches the region of the gazed real image at the time of generating the gazed virtual image 501 (timing T1). In a case where the position and orientation information has not changed, the imaging range (angle of view) of the imaging unit 201 does not change, and thus a gazed virtual image 503 after correction is acquired by extracting the image of the region 502 from the gazed virtual image 501. The same applies to a case where the change amount of the position and orientation information is small (less than a threshold).

FIG. 5B illustrates an example of a case where the position and orientation information is changed so that the imaging range of the imaging unit 201 is shifted in the upper right direction. An image 504 is a gazed virtual image before correction, and a region 505 is a region that matches the region of the gazed real image at the time of generating the gazed virtual image 504 (timing T1). A region 506 is a region that matches the region of the gazed real image after the shift of the imaging range (timing T2). The region 506 is determined by shifting the region 505 in the upper right direction on the basis of the change in the position and orientation information. Then, by extracting the image of the region 506 from the gazed virtual image 504, a gazed virtual image 507 after correction is acquired. Note that the gazed virtual image 504 may be shifted in the lower left direction on the basis of the change in the position and orientation information, and the image of the region 505 may be extracted from the gazed virtual image 504 after the shift to acquire the gazed virtual image 507 after correction.

FIG. 5C illustrates an example in which the size of the gazed virtual image before correction is equal to the size of the gazed real image. An image 508 is a gazed virtual image before correction, and the region of the gazed virtual image 508 matches the region of the gazed real image at the time of generating the gazed virtual image 508 (timing T1). A region 509 is a region that matches the region of the gazed real image after the shift of the imaging range (timing T2). As in the case of FIG. 5B, the region 509 is determined by shifting the region of the gazed virtual image 508 in the upper right direction on the basis of the change in the position and orientation information. Then, by extracting a portion of the gazed virtual image 508 in the region 509, a gazed virtual image 510 after correction is acquired. The gazed virtual image 510 includes a region 511 (non-drawing region) that is not the gazed virtual image 508. As described above, in a case where the size of the gazed virtual image before correction is equal to the size of the gazed real image, the non-drawing region is likely to be included in the gazed virtual image after correction. If the gazed virtual image after correction includes the non-drawing region, a partially missing display image is generated. Thus, in the first embodiment, the size of the gazed virtual image before correction is made larger than the size of the gazed real image.

FIG. 5D illustrates an example in which the position and orientation information changes so that a certain position is imaged from a different direction. An image 512 is a gazed virtual image before correction, and a region 513 is a region that matches the region of the gazed real image at the time of generating the gazed virtual image 512 (timing T1). In the gazed virtual image 512, a region 515 that is a part of a virtual object 514 is drawn. In FIG. 5D, the outline of the virtual object 514 is indicated by a dashed line outside the gazed virtual image 512 so that the entire virtual object 514 can be grasped. The region 513 does not include the virtual object 514. An image 516 is a gazed virtual image obtained by deforming the region 515 so as to change the orientation of the virtual object 514 on the basis of the change in the position and orientation information. A region 517 is a region that matches the region of the gazed real image after the position and orientation of the HMD 101 change (timing T2). Here, for ease of description, it is assumed that the region 517 is equal to the region 513. The region 517 includes a part of the region 518 (a part of the virtual object 514) obtained by deforming a region 515. A gazed virtual image 519 after correction is acquired by extracting the image of the region 517 from the gazed virtual image 516. As described above, since the size of the gazed virtual image before correction is larger than the size of the gazed real image, it is possible to obtain the gazed virtual image after correction in which the virtual object is suitably drawn even in a case where the virtual object enters a region that matches the region of the gazed real image.

The entire CG correction unit 206 corrects the entire virtual image received from the image processing device 104 via the HMD-I/F 204 on the basis of the change in the position and orientation information output from the position and orientation sensor 202. Here, the timing at which the position and orientation information (and the real image corresponding thereto) is acquired and the virtual image is generated is also set as timing T1, and the timing at which the entire CG correction unit 206 (and the gazed CG correction unit 205) performs processing is set as the timing T2. The timing T2 is later than the timing T1. The entire CG correction unit 206 corrects the entire virtual image at the timing T1 so as to correspond to the entire real image at the timing T2 on the basis of the difference between the position and orientation information at the timing T1 and the position and orientation information at the timing T2. The entire CG correction unit 206 changes the shape, size, and the like of the entire virtual image so that the image of the virtual object viewed from the position and orientation of the HMD 101 (imaging unit) at the timing T2 can be obtained. The process of changing the shape, size, and the like of the entire virtual image includes a shift in the horizontal direction, a shift in the vertical direction, magnification, reduction, geometric transformation (for example, homography transformation), and the like. Then, the entire CG correction unit 206 extracts an image of a region that matches the region (entire region) of the entire real image at the timing T2 from the entire virtual image after changing the shape, size, and the like, and outputs the extracted image as an entire virtual image after correction.

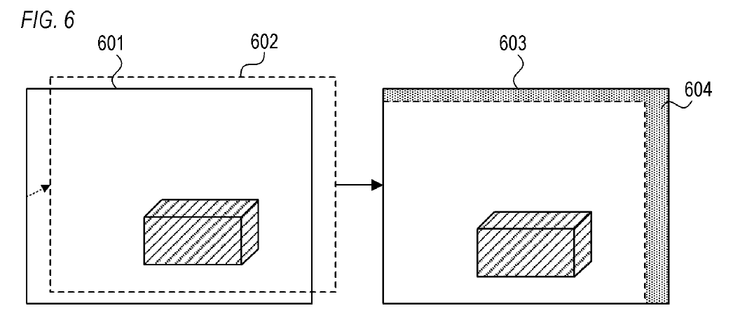

FIG. 6 is a schematic diagram illustrating an example of processing of the entire CG correction unit 206. The processing of the entire CG correction unit 206 is similar to the processing of the gazed CG correction unit 205. FIG. 6 illustrates an example of a case where the position and orientation information has changed so that the imaging range of the imaging unit 201 is shifted in the upper right direction. An image 601 is the entire virtual image before correction, and the region of the entire virtual image 601 matches the region of the entire real image at the time of generating the entire virtual image 601 (timing T1). A region 602 is a region that matches the region of the entire real image after the shift of the imaging range (timing T2). The region 602 is determined by shifting the region of the entire virtual image 601 in the upper right direction on the basis of the change in the position and orientation information. Then, the entire virtual image 603 after the correction is acquired by extracting a portion of an entire virtual image 601 in the region 602. The entire virtual image 603 includes a region 604 (non-drawing region) that is not the entire virtual image 601, but the region 604 corresponds to the peripheral field of view and is thus hardly perceived by the user. Black display may be performed in the region 604, or an image may be drawn in the region 604 by exterior interpolation. In addition, similarly to the gazed region, the size of the entire virtual image before correction may be made larger than the size of the entire real image.

The gazed image compositing unit 207 combines the gazed virtual image after correction by the gazed CG correction unit 205 with the gazed real image (the gazed real image at the timing T2 described above) output from the imaging unit 201, thereby generating a gazed composite image. For example, the gazed virtual image is combined with the gazed real image by chroma key compositing, alpha blending, or the like. Depth information of the real space and depth information of the virtual object may be further acquired, and more advanced compositing processing in consideration of the front-back relationship between a real object and a virtual object may be performed using the depth information. Various known techniques can be used to acquire the depth information.

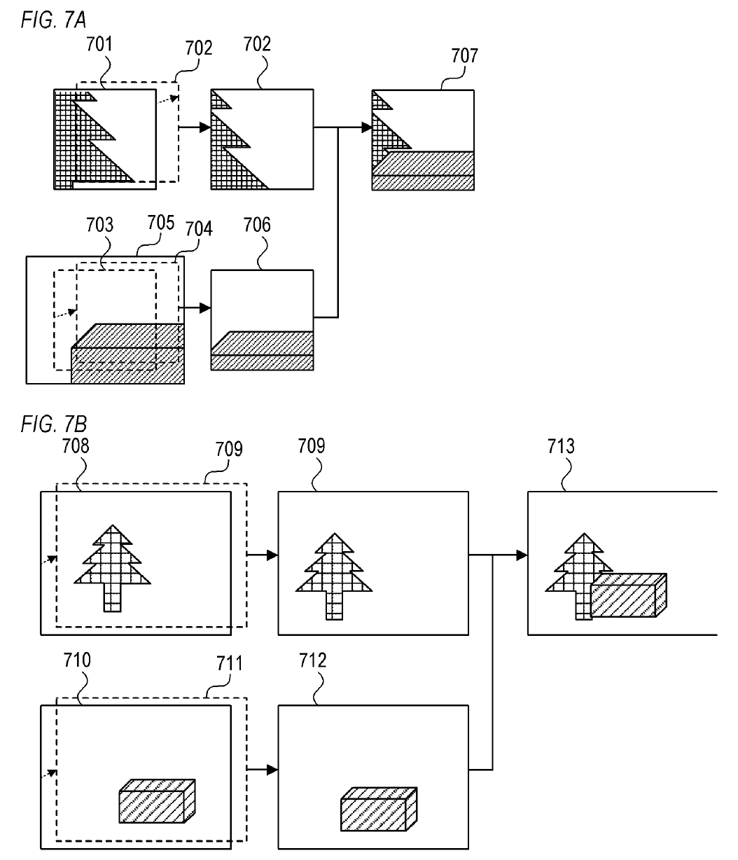

FIG. 7A is a schematic diagram illustrating an example of processing of the gazed image compositing unit 207. FIG. 7A illustrates an example of a case where the position and orientation information changes so that the imaging range of the imaging unit 201 is shifted in the upper right direction. An image 705 is a gazed virtual image before correction by the gazed CG correction unit 205, an image 701 is a gazed real image at the time of generating the gazed virtual image 705 (timing T1), and a region 703 is a region that matches the region of the gazed real image 701. An image 702 is a gazed real image after the shift of the imaging range (timing T2), and a region 704 is a region that matches the region of the gazed real image 702. The gazed CG correction unit 205 extracts the image of the region 704 from the gazed virtual image 705 to acquire a gazed virtual image 706 after correction. The gazed image compositing unit 207 combines the gazed virtual image 706 with the gazed real image 702, thereby generating a gazed composite image 707.

The entire image compositing unit 208 combines the entire virtual image after correction by the entire CG correction unit 206 with the entire real image (the entire real image at the timing T2 described above) output from the imaging unit 201, thereby generating an entire composite image. For example, the entire virtual image is combined with the entire real image by chroma key compositing, alpha blending, or the like. Depth information of the real space and depth information of the virtual object may be further acquired, and more advanced compositing processing in consideration of the front-back relationship between a real object and a virtual object may be performed using the depth information. Various known techniques can be used to acquire the depth information.

FIG. 7B is a schematic diagram illustrating an example of processing of the entire image compositing unit 208. Similarly to FIG. 7A, FIG. 7B illustrates an example of a case where the position and orientation information changes so that the imaging range of the imaging unit 201 is shifted in the upper right direction. An image 710 is an entire virtual image before correction by the entire CG correction unit 206, an image 708 is an entire real image at the time of generating the entire virtual image 710 (timing T1), and the region of the entire virtual image 710 matches the region of the entire real image 708. An image 709 is an entire real image after the shift of the imaging range (timing T2), and a region 711 is a region that matches the region of the entire real image 709. The entire CG correction unit 206 extracts a portion of the entire virtual image 710 in the region 711 to acquire an entire virtual image 712 after correction. The entire image compositing unit 208 combines the entire virtual image 712 with the entire real image 709, thereby generating an entire composite image 713.

The display image compositing unit 209 combines the gazed composite image generated by the gazed image compositing unit 207 with the entire composite image generated by the entire image compositing unit 208 to generate a display image.

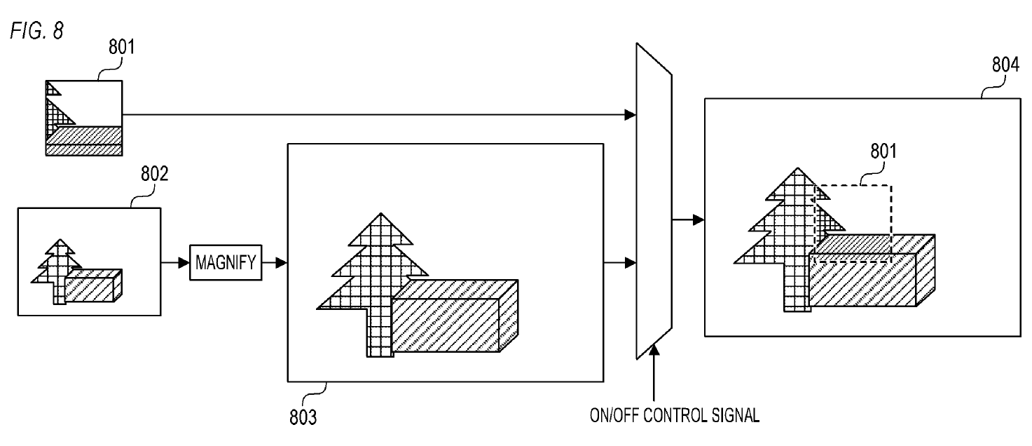

FIG. 8 is a schematic diagram illustrating an example of processing of the display image compositing unit 209. An image 801 is a gazed composite image generated by the gazed image compositing unit 207, and the image 802 is an entire composite image generated by the entire image compositing unit 208. It is assumed that the gazed composite image 801 is an image at equal magnification (1x), and the entire composite image 802 is an image at 1/4 magnification. The display image compositing unit 209 performs scaling to increase the magnification of the entire composite image 802 to the same magnification of the gazed composite image 801, and combines the gazed composite image 801 with an entire composite image 803 after the scaling. The gazed composite image 801 is combined at the position set by the gazed region setting unit 212. Thus, a display image 804 is generated.

Note that on (execution) and off (non-execution) of the processing of the display image compositing unit 209 may be switched by a control signal. Normally, the user cannot clearly recognize the real space when shaking the head quickly. Thus, in such a case, displaying the high resolution gazed composite image causes a sense of discomfort. Accordingly, in a case where the change amount (difference between the position and orientation information at the timing T1 and the position and orientation information at the timing T2) of the position and orientation information from the timing T1 to the timing T2 is equal to or larger than the threshold, the processing of the display image compositing unit 209 need not be performed. In a case where the processing of the display image compositing unit 209 is not performed, the entire composite image is adopted as a display image. In addition, in general, the angular velocity of motion that is likely to cause visually induced motion sickness is 60 [deg/sec]. Thus, when the change amount of the position and orientation information from the timing T1 to the timing T2 corresponds to the orientation change at the angular velocity of 60 [deg/sec] or more, the processing of the display image compositing unit 209 need not be performed. In a case where the gazed virtual image after correction includes the non-drawing region, the processing of the display image compositing unit 209 need not be performed.

The display unit 203 displays the display image generated by the display image compositing unit 209. In the first embodiment, the display unit 203 includes a display unit for the left eye and a display unit for the right eye. The above-described processing is performed for each of the left eye and the right eye, and a display image for the left eye and a display image for the right eye are generated. Then, the display image for the left eye is displayed on the display unit for the left eye, and the display image for the right eye is displayed on the display unit for the right eye.

Meanwhile, in order to display the gazed composite image at the set position, it is necessary to perform scaling of the entire composite image after the entire gazed composite image is buffered. Thus, it is preferable that the HMD 101 receive the gazed virtual image before the entire virtual image from the image processing device 104 and generate the gazed composite image before the entire composite image. The image processing device 104 preferably transmits the gazed virtual image to the HMD 101 before the entire virtual image. Similarly, the imaging unit 201 preferably outputs the gazed real image before the entire real image. This can reduce the display latency.

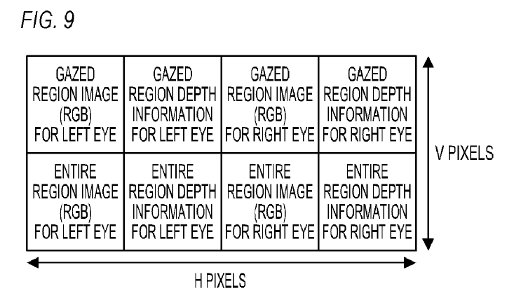

FIG. 9 is a schematic diagram illustrating an example of an image transmitted from the image processing device 104 to the HMD 101. FIG. 9 illustrates an example of a case where the gazed virtual image, the depth information corresponding to the gazed virtual image, the entire virtual image, and the depth information corresponding to the entire virtual image are transmitted as one image from the image processing device 104. In FIG. 9, the gazed virtual image for the left eye, the depth information corresponding to the gazed virtual image for the left eye, the entire virtual image for the left eye, and the depth information corresponding to the entire virtual image for the left eye are present. Similarly, the gazed virtual image for the right eye, the depth information corresponding to the gazed virtual image for the right eye, the entire virtual image for the right eye, and the depth information corresponding to the entire virtual image for the right eye are present.

In FIG. 9, the gazed virtual image and the depth information (depth image) corresponding to the gazed virtual image are arranged in the upper half region of the image, and the entire virtual image and the depth information (depth image) corresponding to the entire virtual image are arranged in the lower half region of the image. In a case where the data is transmitted line by line from the upper side to the lower side of the image, the gazed virtual image can be transmitted before the entire virtual image in the arrangement of FIG. 9.

The depth information is used, for example, for compositing processing in consideration of the front-back relationship between a real object and a virtual object. Similarly to the depth information, transparency information for alpha blending may be arranged.

Note that, in order to improve versatility, the size of the image to be transmitted (vertical direction V pixels × horizontal direction H pixels) is preferably a size defined by the VESA standard or the like.

In addition, although an example in which a plurality of pieces of data are transmitted as one piece of image data has been described, each piece of data may be individually transmitted.

As described above, according to the first embodiment, it is possible to obtain an image of a mixed reality space with a small processing load by using foveated capture or foveated rendering. Furthermore, by processing the image of the gazed region and the image of the entire region separately, it is possible to obtain an image of a mixed reality space in which the resolution of the gazed region is high and there is no sense of discomfort. In addition, since the image of the gazed region and the image of the entire region are generated and transmitted between the devices, the amount of data transmission between the devices can be suppressed as compared with a case where one image including the high resolution region and the low resolution region is generated and transmitted between the devices.

### Second Embodiment

A second embodiment of the present disclosure will be described. In the first embodiment, the gazed region is a preset region. In the second embodiment, the line-of-sight information of the user is acquired, and the gazed region is dynamically changed on the basis of the line-of-sight information. The line-of-sight information is, for example, coordinate information indicating a position (line-of-sight position) on the display surface of the display unit 203 to which the line of sight of the user is directed. The line-of-sight information may be angle information indicating a direction of a visual line (line-of-sight direction).

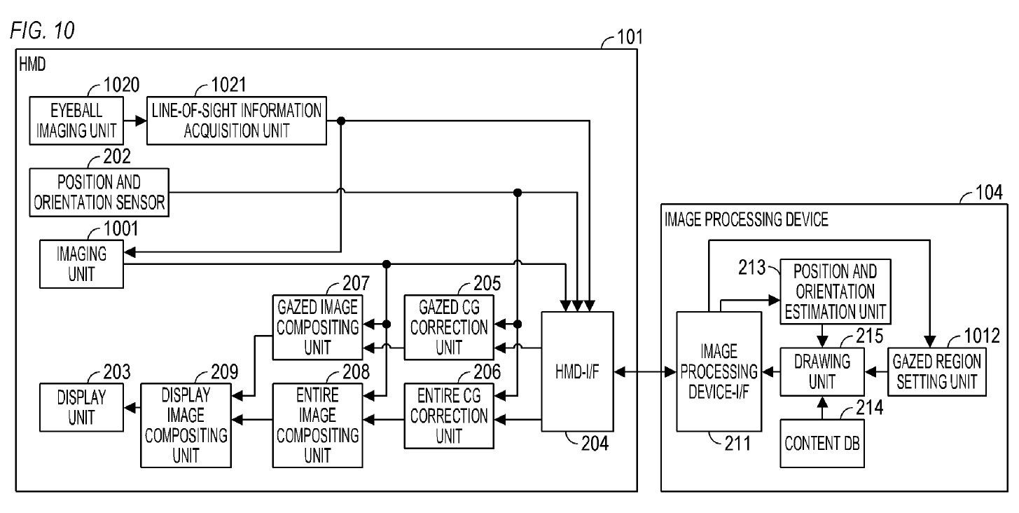

FIG. 10 is a block diagram illustrating a configuration example of an MR system according to the second embodiment. An eyeball imaging unit 1020 of the HMD 101 is a camera that images the eyeball of the user, and acquires an eyeball image. A line-of-sight information acquisition unit 1021 acquires the line-of-sight information of the user by analyzing the eyeball image acquired by the eyeball imaging unit 1020. In the second embodiment, a portion to which the line of sight of the user is directed in the real space is used as the gazed region. An imaging unit 1001 performs processing similar to that of the imaging unit 201 of the first embodiment (FIG. 1). However, the imaging unit 1001 dynamically changes the gazed region (region of the gazed real image) on the basis of the line-of-sight information acquisition unit 1021. A gazed region setting unit 1012 of the image processing device 104 receives the line-of-sight information of the user from the HMD 101 via the image processing device-I/F 211. Then, the gazed region setting unit 1012 sets the position (coordinates) and size of the gazed region to be used by the drawing unit 215, the gazed CG correction unit 205, and the display image compositing unit 209 on the basis of the line-of-sight information, and dynamically changes the position and size. Note that processing other than the acquisition of the line-of-sight information and the dynamic change of the gazed region is similar to that in the first embodiment.

As described above, according to the second embodiment, since the gazed region is dynamically changed using the line-of-sight information of the user, the resolution of the gazed region is high, and it is possible to obtain an image of the mixed reality space with higher accuracy without a sense of discomfort.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to obtain an image of a mixed reality space (a space obtained by fusing a real space and a virtual space) without causing a sense of discomfort with a small processing load.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-028663, filed February 26, 2025, which is hereby incorporated by reference herein in its entirety.

What is claimed is:

1. An information processing device comprising one or more processors and/or circuitry configured to:
execute real image acquisition processing of acquiring
a first real image that represents a real space and has a first resolution, and
a second real image that represents a part of the first real image and has a second resolution higher than the first resolution;
execute information acquisition processing of acquiring position and orientation information that is information regarding a position and an orientation of a head mounted display (HMD);
execute virtual image acquisition processing of acquiring
a first virtual image corresponding to the first real image, representing a virtual object, and having a third resolution, and
a second virtual image corresponding to the second real image, representing a part of the first virtual image, and having a fourth resolution higher than the third resolution;
execute correction processing of, on a basis of a difference between position and orientation information at a first timing and position and orientation information at a second timing after the first timing,
correcting the first virtual image at the first timing so as to correspond to a first real image at a third timing after the first timing, and
correcting the second virtual image at the first timing so as to correspond to the second real image at the third timing; and
execute compositing processing of generating a display image to be displayed on the HMD by
generating a first composite image by combining the first virtual image after the correction processing with the first real image at the third timing,
generating a second composite image by combining the second virtual image after the correction processing with the second real image at the third timing, and
combining the second composite image with the first composite image.

2. The information processing device according to claim 1, wherein
a size of the second virtual image before the correction processing is larger than a size of the second real image.

3. The information processing device according to claim 1, wherein
the correction processing includes processing of extracting, from the second virtual image, a portion of the second virtual image in a region that matches a region of the second real image at the third timing.

4. The information processing device according to claim 3, wherein
in a case where the region that matches the region of the second real image at the third timing includes a region that is not the second virtual image before the correction processing, the first composite image is adopted as the display image in the compositing processing.

5. The information processing device according to claim 1, wherein
depth information of the real space is further acquired in the real image acquisition processing,
depth information of the virtual object is further acquired in the virtual image acquisition processing, and
in the compositing processing, the first composite image and the second composite image are generated on a basis of the depth information of the real space and the depth information of the virtual object.

6. The information processing device according to claim 1, wherein
in a case where the difference is equal to or larger than a threshold, the first composite image is adopted as the display image in the compositing processing.

7. The information processing device according to claim 1, wherein
in a case where the difference corresponds to an orientation change at an angular velocity of 60 [deg/sec] or more, the first composite image is adopted as the display image in the compositing processing.

8. The information processing device according to claim 1, wherein
in the virtual image acquisition processing, the second virtual image is acquired before the first virtual image.

9. The information processing device according to claim 8, wherein
in the compositing processing, the second composite image is generated before the first composite image.

10. The information processing device according to claim 1, wherein
the one or more processors and/or circuitry further executes line-of-sight acquisition processing of acquiring line-of-sight information of a user wearing the HMD, and
the second real image represents a portion of the real space to which a line of sight of the user is directed.

11. The information processing device according to claim 1, wherein
the second timing is equal to the third timing.

12. The information processing device according to claim 1, wherein
the first resolution is equal to the third resolution, and
the second resolution is equal to the fourth resolution.

13. A control method of an information processing device, comprising:
acquiring a first real image that represents a real space and has a first resolution;
acquiring a second real image that represents a part of the first real image and has a second resolution higher than the first resolution;
acquiring position and orientation information that is information regarding a position and an orientation of a head mounted display (HMD);
acquiring a first virtual image corresponding to the first real image, representing a virtual object, and having a third resolution;
acquiring a second virtual image corresponding to the second real image, representing a part of the first virtual image, and having a fourth resolution higher than the third resolution;
on a basis of a difference between position and orientation information at a first timing and position and orientation information at a second timing after the first timing, correcting the first virtual image at the first timing so as to correspond to a first real image at a third timing after the first timing;
correcting the second virtual image at the first timing so as to correspond to the second real image at the third timing, on a basis of the difference;
generating a first composite image by combining the first virtual image after the correction with the first real image at the third timing;
generating a second composite image by combining the second virtual image after the correction with the second real image at the third timing; and
generating a display image to be displayed on the HMD by combining the second composite image with the first composite image.

14. A non-transitory computer readable medium that stores a program, wherein the program causes a computer to execute a control method of an information processing device, the control method comprising:
acquiring a first real image that represents a real space and has a first resolution;
acquiring a second real image that represents a part of the first real image and has a second resolution higher than the first resolution;
acquiring position and orientation information that is information regarding a position and an orientation of a head mounted display (HMD);
acquiring a first virtual image corresponding to the first real image, representing a virtual object, and having a third resolution;
acquiring a second virtual image corresponding to the second real image, representing a part of the first virtual image, and having a fourth resolution higher than the third resolution;
on a basis of a difference between position and orientation information at a first timing and position and orientation information at a second timing after the first timing, correcting the first virtual image at the first timing so as to correspond to a first real image at a third timing after the first timing;
correcting the second virtual image at the first timing so as to correspond to the second real image at the third timing, on a basis of the difference;
generating a first composite image by combining the first virtual image after the correction with the first real image at the third timing;
generating a second composite image by combining the second virtual image after the correction with the second real image at the third timing; and
generating a display image to be displayed on the HMD by combining the second composite image with the first composite image.
